(19) United States
(12) Patent Application Publication
(10) Pub. No.: US 2012/0323623 A1
(43) Pub. Date: Dec. 20, 2012

(54) SYSTEM AND METHOD FOR ASSIGNING AN INCIDENT TICKET TO AN ASSIGNEE

(75) Inventor: Navin Sabharwal, New Delhi (IN)

(73) Assignee: HCL AMERICA INC., SUNNYVALE, CA (US)

(21) Appl. No.: 13/162,158

(22) Filed: Jun. 16, 2011

(51) Int. Cl. G06Q 10/06

(52) U.S. Cl. 705/7.14

(57) ABSTRACT

A system, computer-readable storage medium including instructions, and computer-implemented method for assigning an incident ticket to an assignee are disclosed. An incident ticket is received, via a data network, from a device of a customer, the incident ticket including information relating an issue experienced by the customer. A class of incident tickets to which the incident ticket belongs is determined. Performance ratings for assignees that have handled at least one incident ticket in the class of incident tickets are retrieved from a database. An assignee is selected to handle the incident ticket using the performance ratings. A notification is transmitted, via the data network, to a device of the assignee, the notification alerting the assignee that the assignee has been assigned to handle the incident ticket.

### TECHNICAL FIELD

The disclosed embodiments relate generally to a system and method for assigning an incident ticket to an assignee.

### BACKGROUND

Providers of products and/or services typically handle customer issues related to the products and/or services. An incident ticket may be created in an incident management system to track handling of the issue. The incident management system may then assign the incident ticket to an assignee to resolve the issue. Existing incident management systems may assign incident tickets to any assignee within a particular customer support level. For example, existing incident management systems may assign a Level 1 incident ticket to any Level 1 assignee.

### BRIEF DESCRIPTION OF THE DRAWINGS

FIG. 1A is a block diagram illustrating a process of handling incident tickets, according to some embodiments.

FIG. 1B is a block diagram illustrating further operations in the process of handling incident tickets, according to some embodiments.

FIG. 1C is a block diagram illustrating further operations in the process of handling incident tickets, according to some embodiments.

FIG. 1D is a block diagram illustrating further operations in the process of handling incident tickets, according to some embodiments.

FIG. 2 is a block diagram illustrating components of an incident management system, according to some embodiments.

FIG. 3 is a flowchart of a method for evaluating assignee performance of an incident ticket, according to some embodiments.

FIG. 4 is a flowchart of a method for calculating a performance score for an assignee, according to some embodiments.

FIG. 5 is a flowchart of a method for determining a metric score corresponding to a level of performance an assignee achieved in handling an incident ticket with respect to a performance metric, according to some embodiments.

FIG. 6 is a flowchart of a method for calculating an average performance score for a class of incident tickets handled by an assignee, according to some embodiments.

FIG. 7 is a flowchart of a method for assigning an incident ticket to an assignee, according to some embodiments.

FIG. 8 is a flowchart of a method for determining a class of incident tickets to which an incident ticket belongs, according to some embodiments.

FIG. 9 is a flowchart of a method for selecting an assignee to handle an incident ticket, according to some embodiments.

FIG. 10 is a block diagram of a machine, according to some embodiments.

Like reference numerals refer to corresponding parts throughout the drawings.

### DESCRIPTION OF EMBODIMENTS

### Overview

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

As discussed above, existing incident assignment may assign incident tickets to any assignee in a particular customer support level. However, some assignees in the particular customer support level may have more experience in handling certain types of incident tickets than other assignees in the particular customer support level. Furthermore, depending on the complexity of the incident ticket, it may not be appropriate to assign the incident ticket to a Level 1 customer support assignee. For example, it may be desirable and more efficient to assign a complex incident ticket to a Level 2 or a Level 3 customer support assignee without first assigning the complex incident ticket to a Level 1 customer support assignee.

Thus, some embodiments provide a system and computer-implemented method for assigning incident tickets to assignees based on the past performance of assignees with respect to similar types of incident tickets. In some embodiments, the incident tickets are incident tickets for information technology (IT) products and/or services.

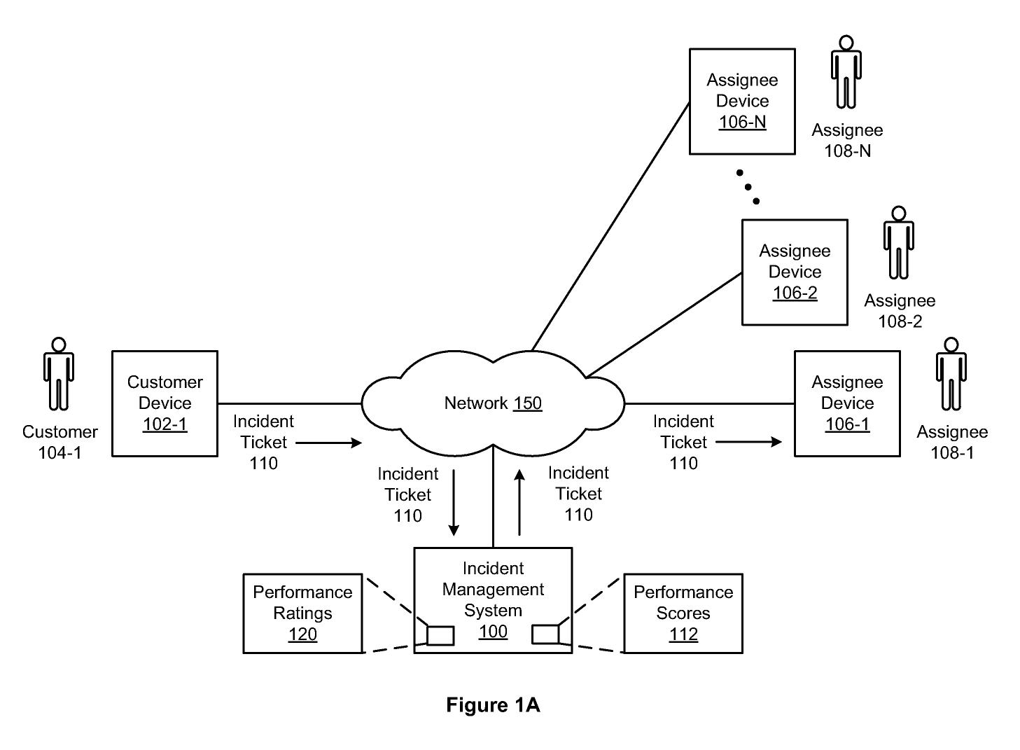

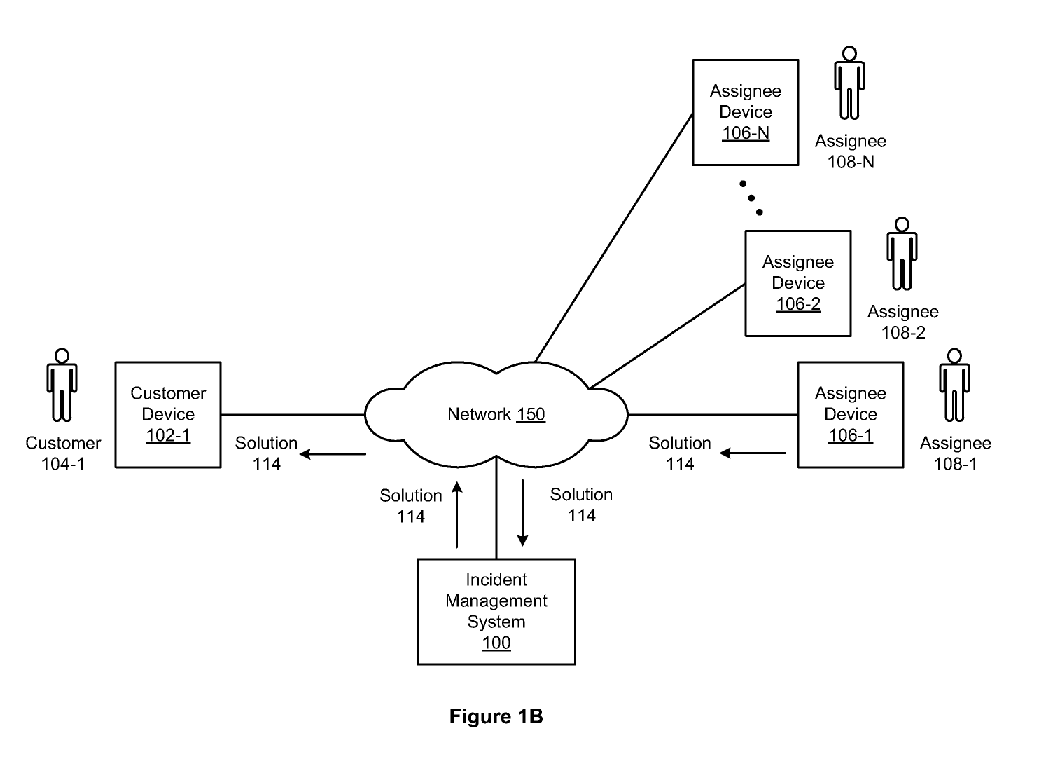

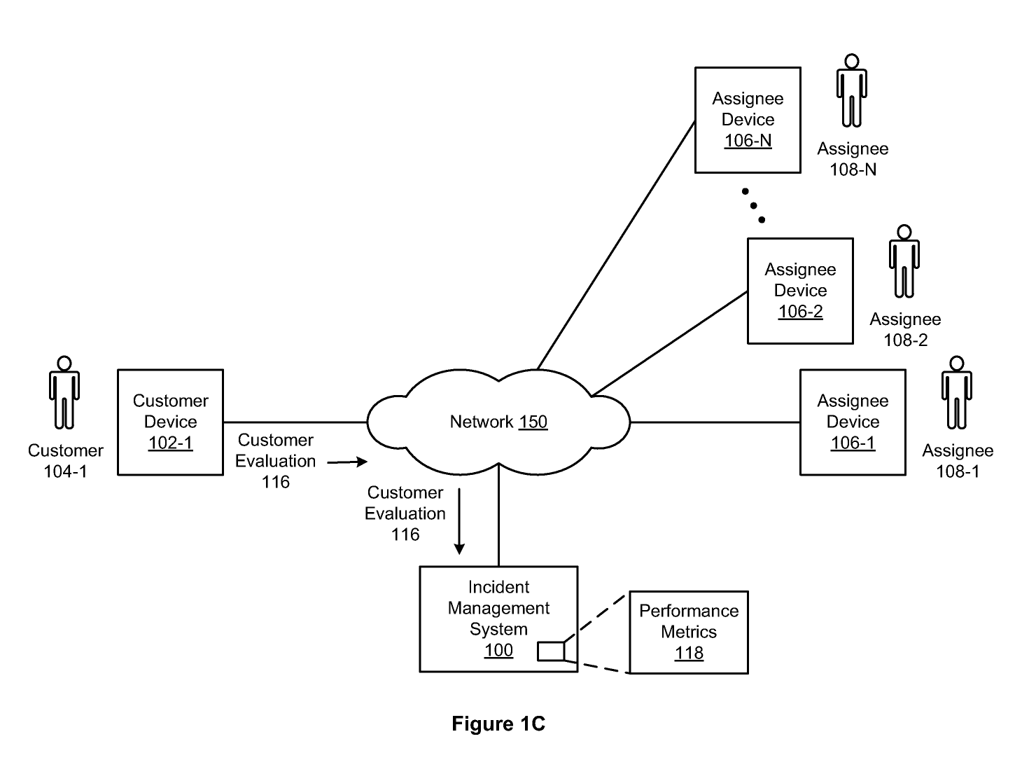

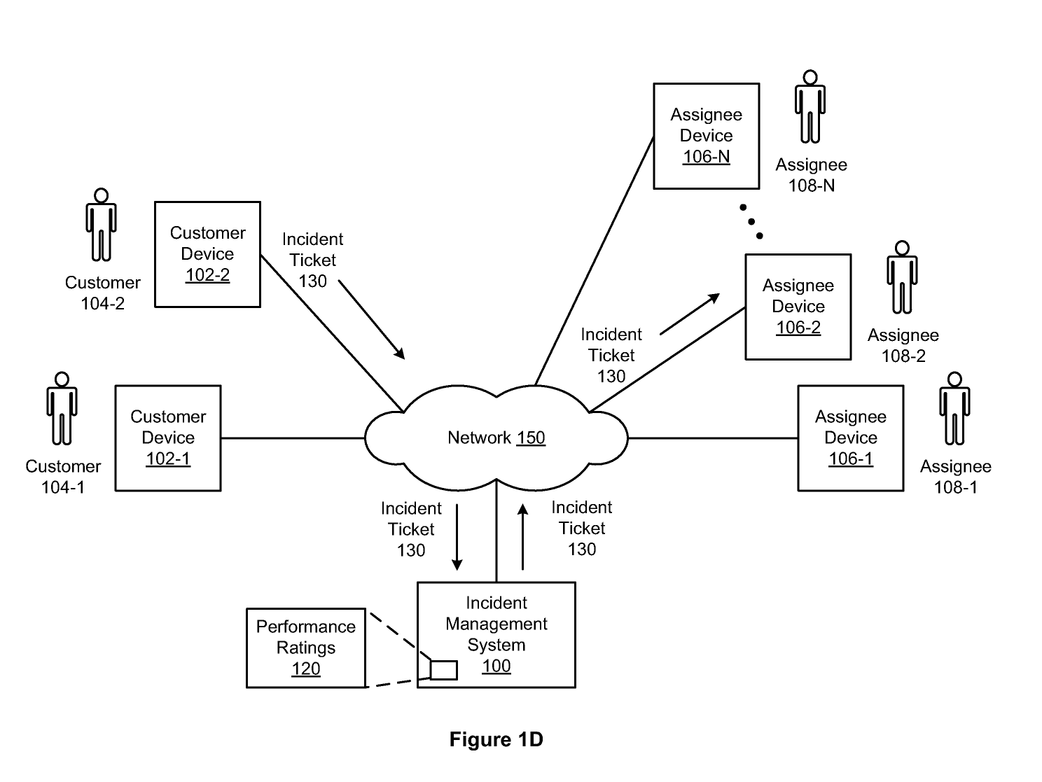

FIGS. 1A-1D are block diagrams illustrating a process of handling incident tickets, according to some embodiments. In FIG. 1A, a customer 104-1 uses a customer device 102-1 to submit an incident ticket 110 to an incident management system 100 for a business via network 150. In some embodiments, the incident ticket 110 includes information related to an issue that the customer 104-1 has with a product or service provided by the business.

Network 150 can generally include any type of wired or wireless communication channel capable of coupling together computing nodes. This includes, but is not limited to, a local area network (LAN), a wide area network (WAN), or a combination of networks. In some embodiments, network 150 includes the Internet. In some embodiments, network 150 is a data network. In some embodiments, the customer device 102-1 includes any type of computer system including a processor and memory. For example, the customer device 102-1 may include, but not limited to, a desktop computer system, a portable computer system, a workstation, a server, a personal digital assistant (PDA), a mobile phone, a smart phone, a multimedia player, a gaming console, and a set top box.

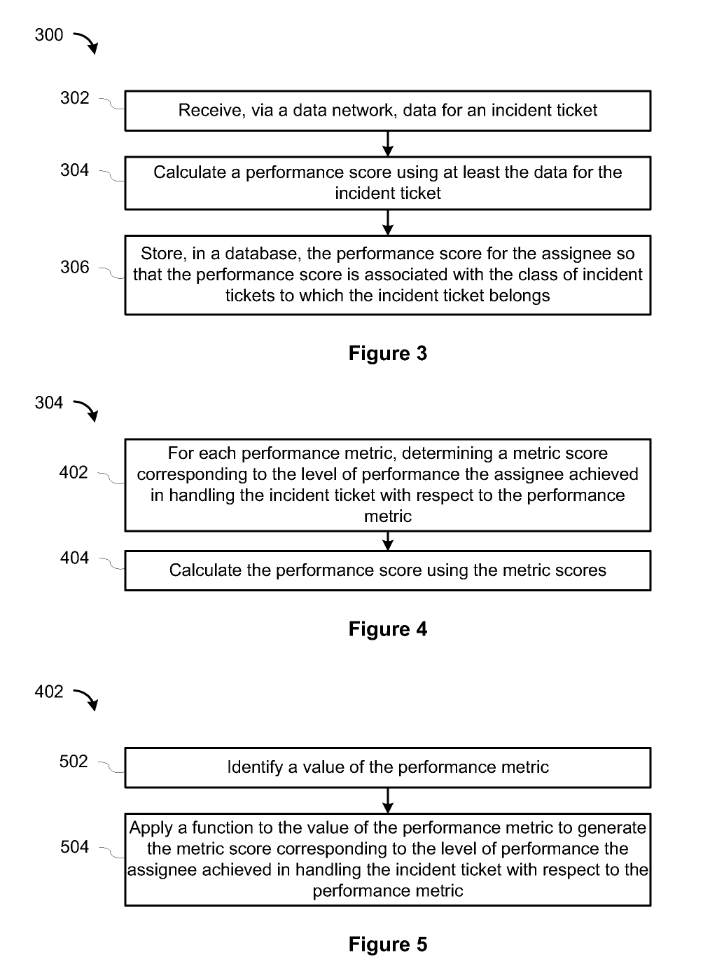

In some embodiments, the incident management system 100 selects an assignee 108-1 to handle the incident ticket 110 based on performance ratings 120 for assignees 108-1, 108-2, . . . , 108-N. The performance ratings 120 for the assignees 108-1, 108-2, . . . , 108-N are based on performance scores 112 for incident tickets previously handled by the assignees 108-1, 108-2, . . . , 108-N. In other words, the performance ratings 120 are based on historical performance scores 112 for incident tickets previously handled by the assignees 108-1, 108-2, . . . , 108-N. A performance score for an incident ticket handled by an assignee is based on performance metrics related to the handling of the incident ticket by the assignee. In some embodiments, a performance rating for an assignee is associated with a class of incident tickets. These embodiments are described in more detail below with respect to FIG. 3-6.

The incident management system 100 then transmits the incident ticket 110 to an assignee device 106-1 of the assignee 108-1. In some embodiments, the assignee device 106-1 includes any type of computer system including a processor and memory. For example, the customer device 102-1 may include, but not limited to, a desktop computer system, a portable computer system, a workstation, a server, a PDA, a mobile phone, a smart phone, a multimedia player, a gaming console, and a set top box. The process of assigning incident tickets to assignees is described in more detail with respect to FIGS. 7-9 below.

In FIG. 1B, the assignee 108-1 resolves the issue and uses the assignee device 106-1 to transmit a solution 114 to the incident management system 100 via network 150. The solution 114 may be a software patch that resolves the issue, written or verbal instructions on operations to be performed by the customer 104-1 to resolve the issue, a report that indicates the course taken to resolve the issue, and the like. The incident management system 100 then transmits the solution 114 to the customer device 102-1 via network 150. In some embodiments, the assignee 108-1 uses the assignee device 106-1 to transmit the solution 114 to the customer device 102-1 via network 150. Note that in situations where the assignee 108-1 is handling the incident ticket while the assignee 108-1 is communicating with the customer 104-1 (e.g., via phone, chat, etc.), the assignee 108-1 may communicate the solution 114 to the customer 104-1 (e.g., via phone, chat, etc.) and transmit the solution 114 to the incident management system 100 for storage.

In some embodiments, after the assignee 108-1 transmits the solution 114 to the customer 104-1, the customer 104-1 provides a customer evaluation 116 to the incident management system 100 via network 150, as illustrated in FIG. 1C. The customer evaluation 116 allows the customer 104-1 to provide subjective feedback on the performance of the assignee 108-1 with respect to the handling of the incident ticket 110. For example, the customer 104-1 may rate the assignee 108-1 with respect to the professionalism of the assignee 108-1 and/or the speed at which the incident ticket was resolved. In some embodiments, the incident management system 100 uses the customer evaluation 116 to generate a customer satisfaction score for the assignee 108-1. In some embodiments, the incident management system 100 determines objective performance metrics 118 for the assignee 108-1 with respect to the handling of the incident ticket 110.

In some embodiments, the performance metrics 118 include one or more of an amount of time that the assignee took to resolve the incident ticket, a customer satisfaction score, a level of complexity of the incident ticket, a level of compliance with a service level agreement that was achieved by the assignee in handling the incident ticket, a number of times the incident ticket was reopened, a number of times the incident ticket was escalated, a number of other assignees that handled the incident ticket before the assignee handled the incident ticket, a number of other assignees that handled the incident ticket after the assignee handled the incident ticket, and a priority of the incident ticket. In some embodiments, the performance metrics 118 are stored in a database.

In some embodiments, incident management system 100 uses the performance metrics 118 for the assignees to generate the performance scores 112. In some embodiments, the incident management system 100 uses the performance scores 112 for the assignees to generate the performance ratings 120 for the assignees. These embodiments are described in more detail below with respect to FIGS. 3-6 below.

In FIG. 1D, a customer 104-2 uses a customer device 102-2 to submit an incident ticket 130 to the incident management system 100 via network 150. The incident management system 100 selects an assignee 108-2 to handle the incident ticket 130 based on performance ratings 120 for assignees 108-1, 108-2, . . . , 108-N. In this case, the incident management system 100 then transmits the incident ticket 130 to an assignee device 106-2 of the assignee 108-2.

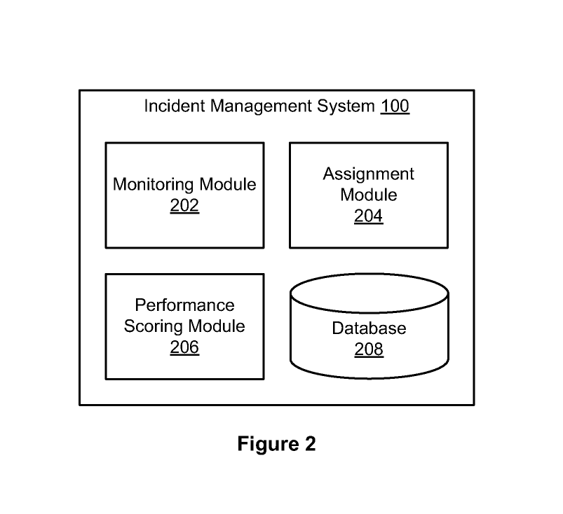

FIG. 2 is a block diagram illustrating components of the incident management system 100, according to some embodiments. The incident management system 100 includes a monitoring module 202, an assignment module 204, a performance scoring module 206, and a database 208. The monitoring module 202 is configured to monitor the progress of incident tickets. The assignment module 204 is configured to assign incident tickets to assignees based on performance ratings for assignees, as described herein. The performance scoring module 206 generates performance scores for assignees based on performance metrics related to the assignees' handling of incident tickets and generates performance ratings for assignees corresponding to classes of incident tickets handled by the assignees based on the performance scores, as described herein. In some embodiments, the database 208 is located on a system that is separate and distinct from the incident management system 100. In some embodiments, the database 208 is a distributed database in which a plurality of databases is located at a plurality of physical locations (e.g., a plurality of geographic locations, a plurality of buildings within a geographic location, etc.). The components of the incident management system 100 are described in more detail below with respect to FIGS. 3-9.

### Evaluating Assignee Performance of an Incident Ticket

FIG. 3 is a flowchart of a method 300 for evaluating assignee performance of an incident ticket, according to some embodiments. The monitoring module 202 receives (302), via a data network (e.g., network 150), data for an incident ticket. In some embodiments, the data includes a class of incident tickets to which the incident ticket belongs and at least one performance metric relating to the handling of the incident ticket by an assignee of the incident ticket. In some embodiments, a class of incident tickets to which an incident ticket belongs includes a level of complexity of the incident ticket and a configuration associated with the incident ticket.

In some embodiments, a level of complexity is indicated by a number in a predetermined range of numbers. For example, the predetermined range may include the numbers 1-10, wherein the level of complexity increases as the numbers increase in value. In some embodiments, the level of complexity is predefined based on the class of incident ticket to which the incident ticket belongs. For example, an incident ticket relating to a network connectivity issue be set to 3 (where 1 indicates a low level of complexity and 10 indicates a high level of complexity) whereas an incident ticket relating to a crashing program may be set to 7.

In some embodiments, the level of complexity of the incident ticket is determined based on historical performance metrics for incident tickets in the class of incident tickets. For example, a short resolution time for incident tickets in the class of incident tickets may indicate that the class of incident tickets has a low level of complexity. In contrast, a long resolution time and/or multiple escalations of incident tickets in the class of incident tickets may indicate that the class of incident tickets has a high level of complexity. In some embodiments, the level of complexity of the incident tickets in the class of incident tickets is determined by a group of assignees or managers. In some embodiments, the level of complexity of the incident tickets in the class of incident tickets is determined by a standards organization.

In some embodiments, the configuration associated with the incident ticket includes the configuration of a device of the customer (e.g., the customer who reports or submits the incident ticket) that is a subject of the incident ticket. In some embodiments, the configuration of the device is selected from the group consisting of: a version number of the device, information about hardware included in the device, manufacturer and model numbers for the hardware included in the device, information about software included in the device, and version numbers for software included in the device. The class of incident tickets (e.g., a complexity and/or a configuration) may be a factor to consider when assigning incident tickets to assignees. For example, a networking issue on a Windows computer system may require a different solution (and a different skill set) than a networking issue on a Macintosh computer system. In general, an assignee trained to handle issues on a Windows computer system should not be assigned to handle issues on a Macintosh computer system. Similarly, a networking issue may be more complex than a password reset issue (e.g., where a user has forgotten a login password). Merely assigning the incident ticket to any first level assignee may not be the most efficient route to take.

The performance scoring module 206 calculates (304) a performance score using at least the data for the incident ticket. In some embodiments, the performance score corresponds to a level of performance the assignee achieved in handling the incident ticket. Attention is now directed to FIG. 4, which is a flowchart of a method for calculating (304) a performance score for an assignee, according to some embodiments. For each performance metric, the performance scoring module 206 determines (402) a metric score corresponding to the level of performance the assignee achieved in handling the incident ticket with respect to the performance metric. Attention is now directed to FIG. 5, which is a flowchart of a method for determining (402) a metric score corresponding to a level of performance an assignee achieved in handling an incident ticket with respect to a performance metric, according to some embodiments. The performance scoring module 206 identifies (502) a value of the performance metric and applies (504) a function to the value of the performance metric to generate the metric score corresponding to the level of performance the assignee achieved in handling the incident ticket with respect to the performance metric. In some embodiments, the function is a mapping function that maps the value of the performance metric to the metric score, wherein the metric score corresponds to a range of values that includes the value of the performance metric. For example, if the performance metric is an amount of time that the assignee took to resolve the incident ticket and the assignee took 10 minutes to resolve the incident ticket, the mapping function may map the performance metric to a value of 5. Similarly, if the performance metric is an amount of time that the assignee took to resolve the incident ticket and the assignee took 50 minutes to resolve the incident ticket, the mapping function may map the performance metric to a value of 1. In some embodiments, the function is a normalization function that normalizes the value of the performance metric to a normalized value within a predetermined range of values. In some embodiments, the function applies predetermined weights to the performance metrics and computes a sum of the weighted performance metrics.

Returning to FIG. 4, the performance scoring module 206 calculates (404) the performance score using the metric scores. In some embodiments, the performance scoring module 206 calculates the performance score using the metric scores by calculating a sum of the metric scores. In some embodiments, the performance scoring module 206 calculates the performance score using the metric scores by applying predetermined weights to the metric scores to produce weighted metric scores and calculating a sum of the weighted metric scores. In some embodiments, the performance scoring module 206 calculates the performance score using the metric scores by applying a multivariable function to the metric scores to generate the performance score.

Returning to FIG. 3, the performance scoring module 206 then stores (306), in a database (e.g., the database 208), the performance score for the assignee so that the performance score is associated with the class of incident tickets to which the incident ticket belongs.

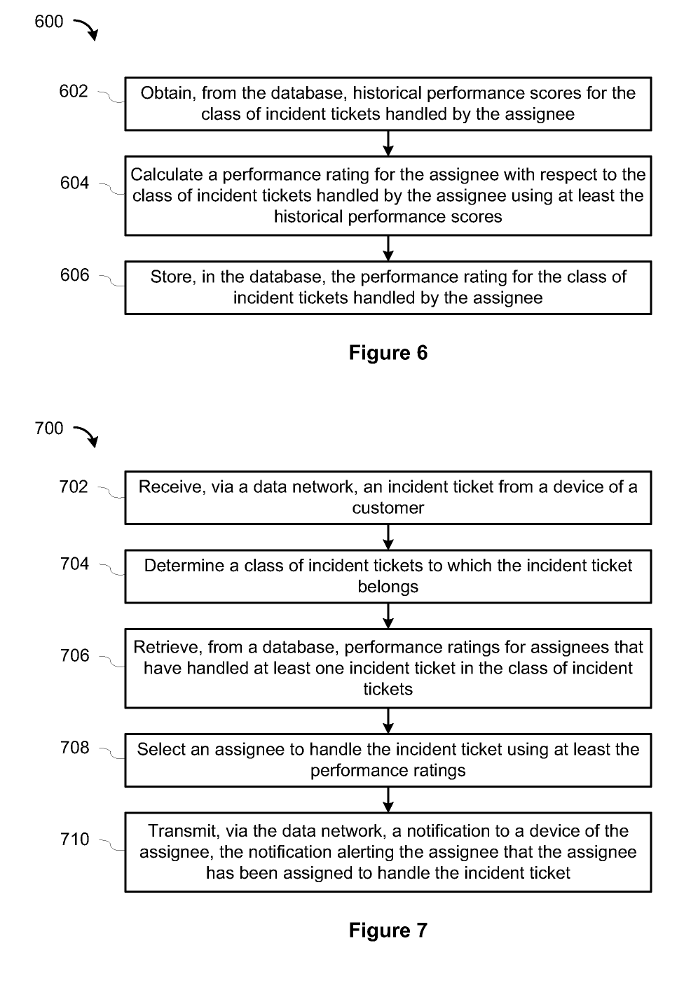

FIG. 6 is a flowchart of a method for calculating an average performance score for a class of incident tickets handled by an assignee, according to some embodiments. The performance scoring module 206 obtains (602), from a database (e.g., the database 208), historical performance scores for the class of incident tickets handled by the assignee. The performance scoring module 206 calculates (604) a performance rating for the assignee with respect to the class of incident tickets handled by the assignee using at least the historical performance scores. In some embodiments, the performance rating for the assignee with respect to the class of incident tickets handled by the assignee is calculated as an average of the historical performance scores for the class of incident tickets handled by the assignee. The performance scoring module 206 then stores (606), in the database, the average performance score for the class of incident tickets handled by the assignee. In some embodiments, the average of the historical performance scores is an arithmetic mean of the historical performance scores. In some embodiments, the average of the historical performance scores is a moving average of the historical performance scores over a predetermined time period.

The following example illustrates an exemplary process for calculating performance scores. Assume that Assignee A and Assignee B are at the same skill level (e.g., Level 1) and have each handled one incident ticket in a class of incident tickets. Table 1 illustrates exemplary data for the incident ticket that each assignee handled and the corresponding performance scores.

TABLE 1
Exemplary Performance Data and Scores

| | Assign- | Assign- |
|---|---|---|
| Parameters | ee A | ee B |
| Amount of time to resolve incident ticket (+) | 2 | 4 |
| Customer satisfaction score (+) | 3 | 3 |
| Level of complexity of incident ticket(+) | 4 | 3 |
| Level of compliance with a service level agreement | 1 | 1 |
| (SLA) (+) | | |
| A number of times the incident ticket was reopened (−) | 0 | 0 |
| A number of times the incident ticket was escalated (+) | 3 | 2 |
| A number of other assignees that handled the incident | 0 | 2 |
| ticket before the assignee handled the incident ticket | | |
| (+) | | |
| A number of other assignees that handled the incident | 1 | 1 |
| ticket after the assignee handled the incident ticket (−) | | |
| Performance Score | 12 | 14 |

As illustrated in Table 1, Assignee A has a performance score of 12 and Assignee B has a performance score of 14. Thus, Assignee B is deemed to be a better assignee to handle incident tickets in this class of incident tickets.

Note that in this example, the performance metrics include positive performance metrics (+) whose values are added to the performance score and negative performance metrics (−) whose values are subtracted from the performance score. In this example, the values of the performance metrics for each assignee have been normalized to a range of values between 0 and 5, where a higher value indicates better performance. For example, an amount of time to resolve incident tickets of a particular complexity may be 15 minutes. Thus, a value of “3” may correspond to a ticket resolution time between 13 minutes and 17 minutes, a value of “2” may correspond to a ticket resolution time between 17 minutes and 25 minutes, a value of “1” may correspond to a ticket resolution time between greater than 25 minutes, a value of “4”, may correspond to a ticket resolution time between 5 and 13 minutes, and a value of “5” may correspond to a ticket resolution time of less than 5 minutes.

Also note that in this example, the level of compliance with a SLA is a binary value: when the SLA has been breached, the value is 0 and when the SLA has been met, the value is 1. Alternatively, the level of compliance with a SLA may be represented using a range of values (e.g., from 1 to 5) in which the values represent the extent to which the SLA has been met or breached. For example, if the SLA sets a maximum downtime of 30 minutes, a value of “5” may correspond to a downtime of 5 minutes or less, a value of “4” may correspond to a downtime between 5 minutes and 15 minutes, a value of “3” may correspond to a downtime between 15 minutes and 30 minutes, a value of “2” may correspond to a downtime between 30 minutes and 45 minutes, and a value of “1” may correspond to a downtime greater than 45 minutes.

### Assigning an Incident Ticket to an Assignee

FIG. 7 is a flowchart of a method 700 for assigning an incident ticket to an assignee, according to some embodiments. The assignment module 204 receives (702), via a data network (e.g., network 150), an incident ticket from a device of a customer. In some embodiments, the incident ticket includes information relating to an issue experienced by the customer.

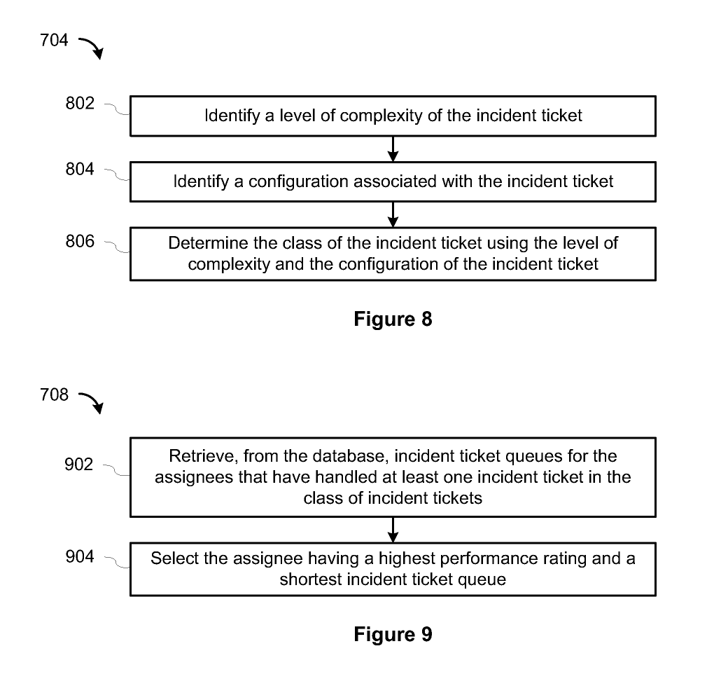

Next, the assignment module 204 determines (704) a class of incident tickets to which the incident ticket belongs. Attention is now directed to FIG. 8, which is a flowchart of a method for determining (704) a class of incident tickets to which an incident ticket belongs, according to some embodiments. The assignment module 204 identifies (802) a level of complexity of the incident ticket and identifies (804) a configuration associated with the incident ticket. In some embodiments, the configuration associated with the incident ticket includes the configuration of a device of the customer that is a subject of the incident ticket. In some embodiments, the configuration of the device is selected from the group consisting of: a version number of the device; hardware included in the device; manufacturer and model numbers for the hardware included in the device; software included in the device; and version numbers for software included in the device. The assignment module 204 then determines (806) the class of the incident ticket using the level of complexity and the configuration of the incident ticket.

Returning to FIG. 7, the assignment module 204 retrieves (706), from a database (e.g., the database 208), performance ratings for assignees that have handled at least one incident ticket in the class of incident tickets, wherein the performance rating corresponds to the assignees performance with respect to the handling of incident tickets in the class of incident tickets. In some embodiments, a respective performance rating for a respective assignee is an average of performance scores that the respective assignee received in handling incidence tickets in the class of incident tickets. In some embodiments, the average of the performance scores is an arithmetic mean of the performance scores. In some embodiments, the average of the performance scores is a moving average of the performance scores over a predetermined time period.

The assignment module 204 then selects (708) an assignee to handle the incident ticket using the performance ratings. In some embodiments, the assignment module 204 selects the assignee to handle the incident ticket using at least the performance ratings by selecting the assignee having a highest performance rating. Attention is now directed to FIG. 9, which is a flowchart of a method for selecting (708) an assignee to handle an incident ticket, according to some embodiments. The assignment module 204 retrieves (902), from the database, incident ticket queues for the assignees that have handled at least one incident ticket in the class of incident tickets. In some embodiments, a respective incident ticket queue includes information relating to pending incident tickets that a respective assignee has been assigned to handle but has not yet completed. The assignment module 204 then selects (904) the assignee having a highest performance rating and a shortest incident ticket queue. In some embodiments, the shortest incident ticket queue is an incident ticket queue that has a fewest number of incident tickets. In some embodiments, the shortest incident ticket queue is an incident ticket queue that has a shortest expected time to completion. Alternatively, assignment module 204 selects (904) the assignee having a highest performance rating and having an incident ticket queue that has a number of pending incident tickets below a predetermined threshold.

Returning to FIG. 7, the assignment module 204 then transmits (710), via the data network, a notification to a device of the assignee, the notification alerting the assignee that the assignee has been assigned to handle the incident ticket.

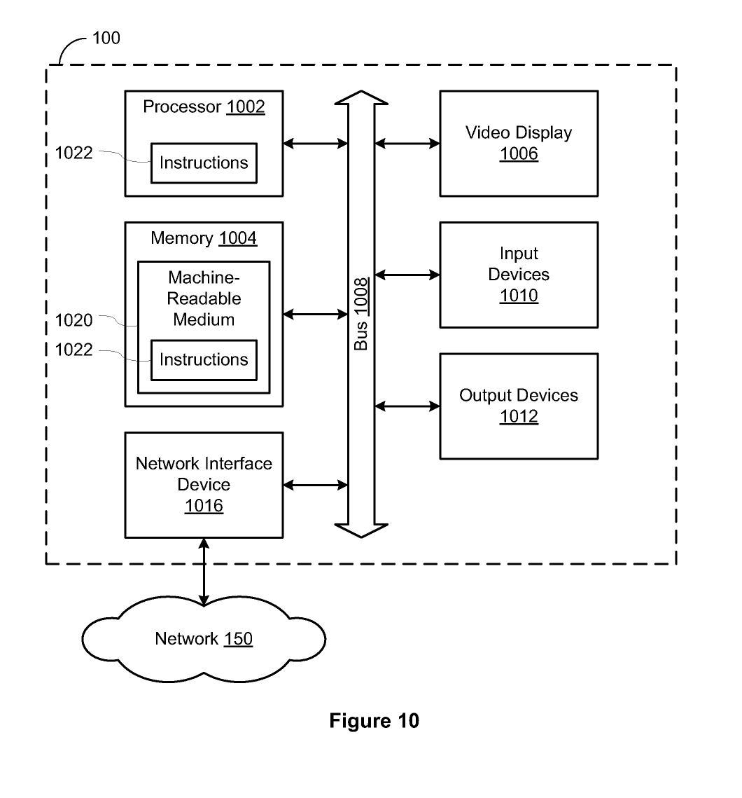

FIG. 10 depicts a block diagram of a machine in the example form of a incident management system 100 within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the incident management system 100 includes a processor 1002 (e.g., a central processing unit (CPU), a graphics processing unit (GPU) or both), and memory 1004, which communicate with each other via bus 1008. Memory 1004 includes volatile memory devices (e.g., DRAM, SRAM, DDR RAM, or other volatile solid state memory devices), non-volatile memory devices (e.g., magnetic disk memory devices, optical disk memory devices, flash memory devices, tape drives, or other non-volatile solid state memory devices), or a combination thereof. Memory 1004 may optionally include one or more storage devices remotely located from the incident management system 100. The incident management system 100 may further include video display unit 1006 (e.g., a plasma display, a liquid crystal display (LCD) or a cathode ray tube (CRT)). The incident management system 100 also includes input devices 1010 (e.g., keyboard, mouse, trackball, touchscreen display, etc.), output devices 1012 (e.g., speakers), and a network interface device 1016. The aforementioned components of the incident management system 100 may be located within a single housing or case (e.g., as depicted by the dashed lines in FIG. 10). Alternatively, a subset of the components may be located outside of the housing. For example, the video display unit 1006, the input devices 1010, and the output devices 1012 may exist outside of the housing, but be coupled to the bus 1008 via external ports or connectors accessible on the outside of the housing.

Memory 1004 includes a machine-readable medium 1020 on which is stored one or more sets of data structures and instructions 1022 (e.g., software) embodying or utilized by any one or more of the methodologies or functions described herein. The one or more sets of data structures may store data. Note that a machine-readable medium refers to a storage medium that is readable by a machine (e.g., a computer-readable storage medium). The data structures and instructions 1022 may also reside, completely or at least partially, within memory 1004 and/or within the processor 1002 during execution thereof by incident management system 100, with memory 1004 and processor 1002 also constituting machine-readable, tangible media.

The data structures and instructions 1022 may further be transmitted or received over the network 150 via network interface device 1016 utilizing any one of a number of well-known transfer protocols (e.g., HyperText Transfer Protocol (HTTP)).

Certain embodiments are described herein as including logic or a number of components, modules, or mechanisms. Modules may constitute either software modules (e.g., code and/or instructions embodied on a machine-readable medium or in a transmission signal) or hardware modules. A hardware module is a tangible unit capable of performing certain operations and may be configured or arranged in a certain manner. In example embodiments, one or more computer systems (e.g., the incident management system 100) or one or more hardware modules of a computer system (e.g., a processor 1002 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 1002 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 1002 configured using software, the general-purpose processor 1002 may be configured as respective different hardware modules at different times. Software may accordingly configure a processor 1002, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 1002 that are temporarily configured (e.g., by software, code, and/or instructions stored in a machine-readable medium) or permanently configured to perform the relevant operations. Whether temporarily or permanently configured, such processors 1002 may constitute processor-implemented (or computer-implemented) modules that operate to perform one or more operations or functions. The modules referred to herein may, in some example embodiments, comprise processor-implemented (or computer-implemented) modules.

Moreover, the methods described herein may be at least partially processor-implemented (or computer-implemented) and/or processor-executable (or computer-executable). For example, at least some of the operations of a method may be performed by one or more processors 1002 or processor-implemented (or computer-implemented) modules. Similarly, at least some of the operations of a method may be governed by instructions that are stored in a computer readable storage medium and executed by one or more processors 1002 or processor-implemented (or computer-implemented) modules. The performance of certain of the operations may be distributed among the one or more processors 1002, not only residing within a single machine, but deployed across a number of machines. In some example embodiments, the processors 1002 may be located in a single location (e.g., within a home environment, an office environment or as a server farm), while in other embodiments the processors 1002 may be distributed across a number of locations.

While the embodiment(s) is (are) described with reference to various implementations and exploitations, it will be understood that these embodiments are illustrative and that the scope of the embodiment(s) is not limited to them. In general, the embodiments described herein may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and its practical applications, to thereby enable others skilled in the art to best utilize the embodiments and various embodiments with various modifications as are suited to the particular use contemplated.

What is claimed is:

1. A computer-implemented method for assigning an incident ticket to an assignee, comprising:
receiving, via a data network, an incident ticket from a device of a customer, the incident ticket including information relating to an issue experienced by the customer;
using at least one processor, determining a class of incident tickets to which the incident ticket belongs;
retrieving, from a database, performance ratings for assignees that have handled at least one incident ticket in the class of incident tickets, the performance ratings corresponding to the assignees performance with respect to the handling of incident tickets in the class of incident tickets;
selecting an assignee to handle the incident ticket using at least the performance ratings; and
transmitting, via the data network, a notification to a device of the assignee, the notification alerting the assignee that the assignee has been assigned to handle the incident ticket.

2. The computer-implemented method of claim 1, wherein determining the class of incident tickets to which the incident ticket belongs includes:
identifying a level of complexity of the incident ticket;
identifying a configuration associated with the incident ticket; and
determining the class of the incident ticket using the level of complexity and the configuration of the incident ticket.

3. The computer-implemented method of claim 2, wherein the configuration associated with the incident ticket includes the configuration of a device that is a subject of the incident ticket.

4. The computer-implemented method of claim 3, wherein the configuration of the device is selected from the group consisting of:
a version number of the device;
information about hardware included in the device;
manufacturer and model numbers for the hardware included in the device;
information about software included in the device; and
version numbers for software included in the device.

5. The computer-implemented method of claim 1, wherein a respective performance rating for a respective assignee is an average of performance scores that the respective assignee received in handling incidence tickets in the class of incident tickets.

6. The computer-implemented method of claim 5, wherein the average of the performance scores is an arithmetic mean of the performance scores.

7. The computer-implemented method of claim 5, wherein the average of the performance scores is a moving average of the performance scores over a predetermined time period.

8. The computer-implemented method of claim 5, wherein selecting the assignee to handle the incident ticket using the performance ratings includes selecting the assignee having a highest performance rating.

9. The computer-implemented method of claim 5, wherein selecting the assignee to handle the incident ticket using the performance ratings includes:
retrieving, from the database, incident ticket queues for the assignees that have handled at least one incident ticket in the class of incident tickets, a respective incident ticket queue including information relating to pending incident tickets that a respective assignee has been assigned to handle but has not yet completed; and
selecting the assignee having a highest performance rating and a shortest incident ticket queue.

10. The computer-implemented method of claim 9, wherein the shortest incident ticket queue is an incident ticket queue that has a fewest number of incident tickets.

11. The computer-implemented method of claim 9, wherein the shortest incident ticket queue is an incident ticket queue that has a shortest expected time to completion.

12. The computer-implemented method of claim 1, further comprising:
receiving data for the incident ticket after the assignee has completed handling the incident ticket, the data including the class of incident tickets to which the incident ticket belongs and performance metrics relating to the handling of the incident ticket by the assignee of the incident ticket;
calculating a performance score for the assignee using the data for the incident ticket, the performance score corresponding to a level of performance the assignee achieved in handling the incident ticket; and
storing, in the database, the performance score for the assignee so that the performance score is associated with the class of incident tickets to which the incident ticket belongs.

13. The computer-implemented method of claim 12, further comprising:
obtaining, from the database, historical performance scores for the class of incident tickets handled by the assignee;
calculating the performance rating for the class of incident tickets handled by the assignee using historical performance scores; and
storing, in the database, the performance rating for the class of incident tickets handled by the assignee.

14. The computer-implemented method of claim 12, wherein a performance metric is selected from the group consisting of:
an amount of time that the assignee took to resolve the incident ticket;
a customer satisfaction score;
a level of complexity of the incident ticket;
a level of compliance with a service level agreement that was achieved by the assignee in handling the incident ticket;
a number of times the incident ticket was reopened;
a number of times the incident ticket was escalated;
a number of other assignees that handled the incident ticket before the assignee handled the incident ticket;
a number of other assignees that handled the incident ticket after the assignee handled the incident ticket; and
a priority of the incident ticket.

15. The computer-implemented method of claim 1, wherein the incident ticket is submitted by a customer of a business and includes information for an issue related to a product or a service of the business.

16. The computer-implemented method of claim 1, wherein the assignee is a person who is assigned to handle the incident ticket.

17. A system to assign an incident ticket to an assignee, comprising:
at least one processor;
memory; and
at least one program stored in the memory, the at least one program comprising instructions to:
receive, via a data network, an incident ticket from a device of a customer, the incident ticket including information relating to an issue experienced by the customer;
determine a class of incident tickets to which the incident ticket belongs;
retrieve, from a database, performance ratings for assignees that have handled at least one incident ticket in the class of incident tickets;
select an assignee to handle the incident ticket using the performance ratings; and
transmit, via the data network, a notification to a device of the assignee, the notification alerting the assignee that the assignee has been assigned to handle the incident ticket.

18. The system of claim 17, wherein the instructions to determine the class of incident tickets to which the incident ticket belongs include instructions to:
identify a level of complexity of the incident ticket;
identify a configuration associated with the incident ticket; and
determine the class of the incident ticket using the level of complexity and the configuration of the incident ticket.

19. A computer readable storage medium storing at least one program configured for execution by a computer, the at least one program comprising instructions to:
receive, via a data network, an incident ticket from a device of a customer, the incident ticket including information relating to an issue experienced by the customer;
determine a class of incident tickets to which the incident ticket belongs;
retrieve, from a database, performance ratings for assignees that have handled at least one incident ticket in the class of incident tickets;
select an assignee to handle the incident ticket using the performance ratings; and
transmit, via the data network, a notification to a device of the assignee, the notification alerting the assignee that the assignee has been assigned to handle the incident ticket.

20. The computer readable storage medium of claim 19, wherein the instructions to determine the class of incident tickets to which the incident ticket belongs include instructions to:
identify a level of complexity of the incident ticket;
identify a configuration associated with the incident ticket; and
determine the class of the incident ticket using the level of complexity and the configuration of the incident ticket.
